(19) United States
(12) Patent Application Publication
(10) Pub. No.: US 2023/0150064 A1
(43) Pub. Date: May 18, 2023

(54) POSITIONING A FIRST AND SECOND METAL PLATE IN A LASER BEAM WELDING POSITION

(71) Applicant: BORIT N.V., Geel (BE)

(72) Inventor: Ronny MARTENS, Geel (BE)

(21) Appl. No.: 17/917,218

(22) PCT Filed: Apr. 1, 2021
(86) PCT No.: PCT/EP2021/058642

§ 371 Date: Oct. 5, 2022

(30) Foreign Application Priority Data
Apr. 6, 2020 (NL) 2025282

(51) Int. Cl. B23K 26/244; B23K 37/04; B23K 26/60

(52) U.S. Cl. CPC B23K 26/244; B23K 37/0408; B23K 26/60; B23K 2101/36

(57) ABSTRACT

Method for positioning a first metal plate and a second metal plate relative to each other in a laser beam welding position, wherein the first metal plate comprises a welding bump. First, the first metal plate and the second metal plate are arranged in a laser beam welding position, such that the welding bump of the first metal plate is projecting towards the second metal plate. Second, the first metal plate and the second metal plate are fixed in the laser beam welding position by using at least one welding fixture and/or reducing a pressure of air between the first metal plate and the second metal plate.

The invention relates to the technical field of fuel cells, in particular the manufacturing of metal bipolar plates for fuel cells.

The invention pertains to a first metal plate and a second metal plate, wherein the first metal plate comprises a welding bump, a method for positioning a first metal plate and a second metal plate, and a method of manufacturing a first metal plate and a second metal plate.

Laser welding is a frequently used welding technique with distinctive advantages, as for example a high productivity and ease of automation. To weld two metal plates together using laser welding, the two plates should be in contact with each other to avoid holes in the welds. Laser welding tools are adapted to press both plates together.

When the plates are joined by laser welding, the mechanical contact between the plates is important. Therefore, it is important that the laser welding tools are positioned relatively close to the location of the weld. The appropriate positioning of the laser welding tools is needed to achieve a reliable and proper weld. It is difficult to guarantee that this requirement is fulfilled everywhere on the metal plate bipolar. The conventional laser welding tools are susceptible to stringent accuracy requirements.

Even though tolerances for the metal plates and laser welding tools are strict, in practice the metal plates do not perfectly align before they are welded together. This may lead to a situation the distance between metal plates after welding is larger on one side than the other, even when the welding process is successful. As such deviation of the design is repeated for every two plates that are welded together, said deviation accumulates for a stack of metal plates.

Further, external factors during laser welding could lead to detrimental effects, as for example the adhesion of sinters to the laser welding tool and plates. This will lead to quality issues of the plates or reduced lifetime of the tool.

The invention aims to provide a solution to mitigate one or more of the issues above, or at least to provide an alternative for the existing devices.

According to a first aspect of the invention, there is provided a first method for positioning a first metal plate and a second metal plate relative to each other in a laser beam welding position, wherein:
the first metal plate comprises a first plate welding zone and a first surface, having a first channel structure, and a first opposite surface, having a first opposite channel structure,
the second metal plate comprises a second plate welding zone and a second surface, having a second channel structure, and a second opposite surface, having a second opposite channel structure, and wherein the second metal plate comprises no welding bump,
the first channel structure and the second channel structure are adapted to form a flow field channel pattern when the first metal plate and the second metal plate are joined together,
the first plate welding zone comprises a welding bump,
   wherein the first method comprises the following steps:
arranging the first metal plate and the second metal plate in a laser beam welding position, such that
   the first channel structure and the second channel structure are positioned to form the flow field channel pattern;
   the welding bump of the first metal plate is projecting towards the second plate welding zone of the second metal plate;
fixing the first metal plate and the second metal plate in the laser beam welding position, by
   using at least one welding fixture, wherein the at least one welding fixture engages the first metal plate next to the first plate welding zone and/or the second metal plate next to the second pate welding zone, and/or
   reducing a pressure of air between the first metal plate and the second metal plate, thereby providing a suction force.

In the first method according to the invention a first metal plate and a second metal plate are positioned relative to each other in a laser beam welding position. When the plates are joined together, the plates can be used as bipolar plates, e.g. for a fuel cell stack, in particular for in a vehicle. Note that throughout the description, the term ‘the plates’ refers to the first metal plate and the second metal plate.

Both plates have two surfaces. A first surface of the first metal plate has a first channel structure and a first opposite surface of the first metal plate has a first opposite channel structure.

Likewise, a second surface of the second metal plate has a second channel structure and a second opposite surface of the second metal plate has a second opposite channel structure.

By joining the first metal plate and the second metal plate together, the first surface of the first metal plate is connected with the second surface of the second metal plate. When the first metal plate and the second metal are joined, the first surface is facing the second surface. As a consequence, a flow field channel pattern is formed by the positioned first channel structure and the second channel structure. Preferably, the flow field channel pattern serves for the flow of a coolant, which e.g. may be water, glycol, or a mixture, when the plates are used in a fuel cell stack. However, it is also possible that the flow field channel pattern serves to guide and divide a gaseous stream, e.g. oxygen or hydrogen.

For example, in general to weld both plates together a laser welding machine is used. The laser welding machine generally comprises a laser beam source to emit a laser beam, a lens system to focus the laser beam at the right spot and a 2D positioning table to move the lens system. Before welding, both plates positioned and fixed in a position. This may e.g. be done in a positioning step and a fixing step performed by a laser welding tool. The laser welding tool may e.g. comprise a positioning system to position the first metal plate and the second metal plate relative to each other in the laser beam welding position and relative to the laser welding machine. The positioning system e.g. comprises a welding holding tool. The laser welding tool further comprises a fixing system to fix both plates in the laser beam welding position. The fixing system e.g. comprises at least one welding fixture and/or a suction force system, e.g. comprising a pump such as a vacuum pump, a venturi, or a compressor configured to reduce the pressure of air between the first metal plate and the second metal plate. In a preferred embodiment, only one of the suction force system or the at least one welding fixture is used to fix both plates in the laser beam welding position. However, in reality, the plates are not completely smooth over their entire surfaces and it is tough to reach a perfect positioning of the plates. Therefore, preferably, both the suction force system and at least one welding fixture are used to fix the plates in the known systems and methods. After the plates are positioned and fixed in the laser beam welding position, the laser beam source of the laser welding machine can be used to weld both plates together by radiation with a laser beam during the welding process. Additionally, during processing argon gas may optionally be dispensed over the plates to mitigate oxidation of the plates.

Preferably, the function of the first opposite channel structure of the first metal plate is to guide and divide a gaseous stream, e.g. hydrogen or oxygen, over the first opposite surface. Preferably, the second opposite channel structure of the second metal plate is to guide and divide a gaseous stream, e.g. oxygen or hydrogen, over the second opposite surface. Thus, these three different channels (the flow field channel pattern, the first opposite channel structure and the second opposite channel structure) can be used to regulate the operation inside a fuel cell, wherein the topology of each channel may be optimised to meet an application's requirements.

For clarity reasons, the flow field channel pattern is referred to as the channel at an inside of the plates, i.e. when the first metal plate and the second metal plate are connected. Note that the terms ‘joined’ and ‘connected’ are used interchangeably throughout the description. However, the flow field channel pattern may also be located at an outside of the plates. Further note, that the first surface and the first opposite surface are interchangeable, meaning that the first surface or the first opposite surface may be located at the outside or at the inside of the plates. The same reasoning applies to the second surface and the second opposite surface of second metal plate.

Further, the first metal plate comprises a first plate welding zone and the second metal plate comprises a second plate welding zone. The first plate welding zone and the second plate welding zone are defined areas. A laser beam is focused within this area of the plate on which the laser beam is emitted when both plates are being welded. The laser beam is radiated by a laser beam source. The laser beam source is e.g. a part of the laser welding machine. In an embodiment, the first plate welding zone and the second plate welding zone are overlapping when the first metal plate and the second metal plate are joined together.

According to the invention, the first plate welding zone comprises a welding bump. The welding bump on the first metal plate is a local deformation of the first metal plate at the first plate welding zone. The second metal plate comprises no welding bump. The welding bump improves the arranging of the plates in the laser beam welding position, as well as the quality of the laser beam welding, despite the fact that the plates may be misaligned relative to each other. This will be explained further below.

The first method according to the invention comprises the step of arranging the first metal plate and the second metal plate in the laser beam welding position, such that the first channel structure and the second channel structure are positioned to form the flow field channel pattern. The first channel structure and/or the second channel structure may comprise protrusions, including alternately flat parts and channels walls. Preferably, both plates are pre-cut, causing identical dimensions (width and length) for the plates in a first plane. The first plane being perpendicular to the protrusions and/or welding bump. Furthermore, in the laser beam welding position, the welding bump of the first metal plate is projecting towards the second plate welding zone of the second metal plate.

Before welding, the first metal plate and the second metal plate are fixed in the laser beam welding position using at least one welding fixture and/or reducing a pressure of air between the first metal plate and the second metal plate, thereby providing a suction force. The at least one welding fixture engages the first metal plate next to the first plate welding zone and/or the second metal plate next to the second plate welding zone. In an embodiment, the at least one welding fixture engages the first metal plate and the second metal plate at a distance of at least 0.3 mm, preferably 0.5-0.8 mm, from a centre of the welding bump. Compared to conventional machines, the welding bump allows that the welding fixture is positioned at a greater distance from the weld, which ensures a diminished amount of splashes or debris on the welding tools and/or plates during the laser beam welding. This leads to a decrease of rework of the plates and an increased life time of the laser welding tools. In an embodiment, only the suction force system is used to fix the first metal plate and the second metal plate in the laser beam welding position.

The at least one welding fixture may e.g. be a structure comprising at least one opening, which structure is pressed on the first metal plate and/or the second metal plate. The at least one welding fixture engages the first metal plate and/or the second metal plate in such a manner that the at least one opening allows that the first plate welding zone and/or the second plate welding zone can be exposed to a laser beam during laser beam welding.

Reducing the pressure of air between the first metal plate and the second metal plate may e.g. be done using the suction force system, e.g. comprising a pump such as a vacuum pump, a venturi or a compressor having an inlet connected to an area between the first and second metal plate. As air is removed from this area, the pressure of the air reduces. As the pressure of the air between the first and second metal plate is lower than the surrounding air, a suction force is provided. The suction force fixes the first and second metal plate in the laser beam welding position.

Due to the inventive welding bump, it may be possible to fix the first and second metal plate appropriately using only one of the welding fixture and the suction force, although it is also possible to use both. In any case, the welding bump allows to reduce the requirements of the welding fixture and/or the suction force. This has benefits including reduced operational cost and reduced maintenance cost.

In an embodiment, the welding bump has a curved shape having a radius of curvature. In an embodiment, the radius of curvature of the welding bump is 0.5-2.5 mm, preferably 0.7-1.5 mm, more preferably 0.8-1.2 mm. Due to the curved shape of the welding bump, an outer point of the welding bump is position out of plane of the first metal plate by a height of the welding bump. The curved shape of the welding bump ensures that the outer point of the welding bump contacts the second metal plate during the positioning step of the method according to the invention. The mechanical contact between the plates is preferred for welding the plates together. The goal is to diminish the distance or gap between the plates. However by applying a welding bump, a gap between the plates adjacent to the welding zones will initially be created. Preferably, the radius of curvature is chosen to avoid that the curvature of the outer point of the welding bump has a steep slope. Preferably, the slope has an inclination of around 1-5%. This can be regarded as a relatively gentle slope. The slope according to this embodiment secures a broad contact between both plates. The broad contact realizes a satisfactory weld, which benefits the flatness of the plates. For example, the radius of curvature is greater than a height of the welding bump.

During the fixing step of the first metal plate and the second metal plate according to this embodiment, the welding bump is partially flattened. The welding bump is pressed against the second metal plate. The welding bump deforms as a result of the fixing step, leading to a reduced height of the welding bump. In this manner, the first metal plate and the second metal plate are positioned on a fixing distance of each other. The fixing distance is smaller than the height of the welding bump.

In a further embodiment, the first metal plate and/or the second metal plate comprises at least one positioning feature. The at least one positioning feature is used for positioning the first metal plate and the second metal plate when the first metal plate and the second metal plate are arranged in a laser beam welding position. The at least one positioning feature is adapted such that the first metal plate and the second metal plate are properly aligned. The positioning feature may e.g. be a local groove and/or a positioning protrusion, which is manufactured at a predetermined location on the plates, e.g. at the corners of the plates.

In a further embodiment, the method according to the invention further comprises the step of joining the first metal plate and the second metal plate by laser beam welding. During this step, the laser beam from the laser beam source is focused at the welding bump of the first metal plate. This may include the laser beam source being emitted onto first opposite surface or second opposite surface on a position corresponding with the welding bump. The welding bump ensures a better contact between the first metal plate and the second metal plate during laser beam welding. This leads to an improved quality of the weld. In addition, the welding bump provides further advantages relating to the quality, namely less adhesion of sinters or debris on the laser welding tool which can be positioned further from the weld and plates.

In an embodiment, the welding bump has a curved shape. During the fixing step of the method according to the invention, the welding bump is pressed against the second plate welding zone of the second metal plate. Consequently, a line or surface contact is created. Further, the at least one welding fixture induces a clamping force on both plates during the fixing step. As a consequence, a reaction force is generated. Due to the spring-like behavior of the welding bump, the shape of the welding bump deforms, e.g. the welding bump partially flattens.

In an embodiment, before the step of joining the first metal plate and the second metal plate, the first metal plate and second metal plate are positioned on a fixing distance of each other. During the step of joining the first metal plate and the second metal plate, the welding bump is at least partially melted by the laser beam. After the step of joining the first metal plate second metal plate, the first metal plate and second metal plate are positioned on a joined distance of each other, said joined distance being smaller than fixing distance.

During laser beam welding, the welding bump is exposed to a laser beam. This generates heat. The welding bump is heated above the melting point. Consequently, the plates will melt locally, i.e. at the welding bump. The height of the welding bump will diminish. The effect is that the distance between the plates decreases. As a result, both plates are welded to each other by the welding bump with a smaller gap between the plates. Further, faults, e.g. due to bad contact of the plates or positioning faults, are not cumulated by stacking the plates. For example, during stacking of bipolar plates, hundreds of plates are stacked. This means that an error of a few μm would result in a worse quality stack, e.g. for use in fuel cells. For example, an unwanted sunken weld is mitigated by the method according to the invention.

In an embodiment, the welding bump has an elongated shape and a length. The elongated shape of the welding bump can be explained as having at least a two-dimensional shape. In a further embodiment, the welding bump may be formed as a closed loop on the first metal plate. For example, the welding bump is produced at a distance along an edge of the first metal plate, e.g. at 10 mm of the edge.

In an embodiment, a height of the welding bump is 5-50 μm, preferably 1-30 μm, more preferably 15-25 μm. A width of the welding bump is 0.2-2 mm, preferably 0.3-1.5 mm, more preferably 0.4-1 mm. Taking into account the width and the height of the welding bump, the welding bump comprises a slope when seen in the direction of the width. The slope has an inclination of around 1-5%. This can be regarded as a relatively gentle slope. The slope according to this embodiment secures a broad contact between both plates. The broad contact realizes a satisfactory weld, which benefits the flatness of the plates.

In an embodiment, a length and/or width of the first plate welding zone is at least as large as a length and/or width of the welding bump of the first metal plate. The area of the first plate welding zone is large enough to prevent that the at least one welding fixture engages the welding bump. In a preferred embodiment, the length and/or width of the first plate welding zone equals the length and/or width of the welding bump on the first metal plate.

In an embodiment, a length and/or width of the second plate welding zone is at least as large as a length and/or width of the welding bump on the first metal plate. The area of the second plate welding zone is large enough to prevent that the at least one welding fixture engages the welding bump. In an embodiment, the length and/or width of the second plate welding zone equals the length and/or width of the welding bump on the first metal plate. Preferably, the length and/or width of the second plate welding zone is larger than the length and/or width of the welding bump on the first metal plate. Preferably, the second plate welding zone completely overlaps the first plate welding zone, when the first metal plate and the second metal plate are positioned in the laser beam welding position. Said overlapping occurs in a plane being perpendicular to a height of the welding bump, e.g. in a horizontal plane.

In an embodiment, a thickness of each of the plates is 20-500 μm, preferably 25-250 μm, more preferably 50-100 μm. To prevent leakage at the location of the welds, it is preferred that the gap between the two plates is as small as possible. An interrupted, broken or defective weld of a few μm may already be sufficient to cause a leak. Optionally, after the step wherein the first metal plate and the second metal plate are fixed and before the plates are joined, a gap between the first metal plate and the second metal plate is smaller than 5 percent, more preferably 3 percent, of the thickness of each of the plates at the location of the welding bump.

In an embodiment, the first method comprises a step of making at least one welding fixture. This may e.g. be based on dimensions of the first metal plate and/or the second metal plate, and/or the flow field channel pattern, and/or the location of the welding bump on the first metal plate. For example, the at least one welding fixture can be a structure, which is cut in a predetermined shape. The at least one welding fixture may e.g. be adapted to be arranged on the plates, e.g. the first and second plate being arranged on top of each other and the at least one welding fixture engaging the plate being arranged on top of the other. Due to the weight of the structure and/or gravity both plates are fixed, when the structure engages one of the two plates. When the plates are fixed, the welding bump remains accessible, e.g. by an opening in the predetermined shape of the structure, for the laser beam.

In a further embodiment, the first method comprises a step of designing the plates. During this step, dimensions of the welding bump are determined based on tolerances of dimensions of the first metal plate and/or the second metal plate, and/or on dimensions of the laser beam to be focused on the welding bump during the laser beam welding.

According to a second aspect of the invention, a second method is provided. The second method is a method for manufacturing a first metal plate and a second metal plate. The second method comprises the following steps:
arranging the first metal plate inside a first mold with a first predetermined shape at an inner surface;
arranging the second metal plate inside a second mold with a second predetermined shape at an inner surface;
injecting first fluid at a first injection pressure into the first mold;
injecting second fluid at a second injection pressure into the second mold;
pressing the first metal plate to the first predetermined shape at the inner surface of the first mold by using the injected fluid, wherein the first predetermined shape deforms the first metal plate causing a first channel structure, a first opposite channel structure, and a welding bump on the first metal plate;
pressing the second metal plate to the second predetermined shape at the inner surface of the second mold by using the injected fluid, wherein the second predetermined shape deforms the second metal plate causing a second channel structure and a second opposite channel structure, wherein the first channel structure and the second channel structure are adapted to form a flow field channel pattern when the first metal plate and the second metal plate are joined together;
removing the first metal plate from the first mold;
removing the second metal plate from the second mold.

In the second method according to the invention, a hydroforming process is used. In practice, hydroforming is a reliable way of accurately forming the welding bump on the first plate. According to the invention, a mold is used to deform the plates. The mold may e.g. be a chamber with a predetermined shape at an inner surface, e.g. at the bottom. In a first possible embodiment, the first metal plate and the second metal plate are manufactured by arranging them simultaneously in a single mold structure, comprising two compartments. Thereby, one of the compartments is referred to as a first mold and the other compartment is referred to as a second mold. Each plate is arranged in a different compartment. The compartments may be arranged parallel to each other.

In another possible embodiment, the two plates are manufactured in different molds and/or not simultaneously, e.g. at different times and/or locations. For example, the first metal plate is manufactured by arranging the first metal plate inside a first mold with a first predetermined shape at an inner surface. In addition, the second metal plate is manufactured by arranging the second metal plate inside a second mold with a second predetermined shape at an inner surface.

When one of the plates is arranged in the mold, the second method according to the invention further comprises the injection of fluid under pressure into the mold. Depending on the type, dimensions and material of the plates, the injection pressure of the fluid inside the first and/or second mold can be between 500-5000 bar, preferably between 1000-3000 bar, more preferably between 1200-2000 bar.

The second method according to the invention further comprises the step of pressing the first metal plate to the first predetermined shape at the inner surface of the first mold by a first injected fluid. Because of a first injection pressure of the first fluid, the first predetermined shape deforms the first metal plate. This deformation causes a first channel structure on the first surface of the first metal plate and a first opposite channel structure on the first opposite surface of the first metal plate. Further, a welding bump on the first metal plate is formed. In an embodiment, the welding bump has a curved shape having a radius of curvature. Due to the curved shape of the welding bump, an outer point of the bump is position out of plane of the first metal plate by a height of the welding bump. Preferably, the radius of curvature is chosen to avoid that the curvature of the outer point of the welding bump has a steep slope. Preferably, the slope has an inclination of around 1-5%. For example, the radius of curvature is greater than a height of the welding bump. Analogous, the second metal plate is pressed to the second predetermined shape at the inner surface of the second mold by a second injected fluid. Preferably, the first injected fluid and the second injected fluid are the same. Because of a second injection pressure of the second fluid, the second predetermined shape deforms the second metal plate. Preferably, the first injection pressure is equal to the second injection pressure. This deformation step causes a second channel structure on the second surface of the second metal plate and a second opposite channel structure on the second opposite surface of the second metal plate. No welding bump is manufactured on the second metal plate.

The first channel structure and the second channel structure are adapted to form a flow field channel pattern when the first metal plate and the second metal plate are joined together. If the plates are joined together, the plates can be used as bipolar plates. When the bipolar plates are used in fuel cells, an electrochemical reaction between hydrogen and oxygen produces heat. Therefore, the flow field channel pattern may e.g. be used to cool the plates by the flow of a coolant, which e.g. may be water. However, it is also possible to use the flow field channel pattern for guiding the flow of reactants, e.g. hydrogen or oxygen.

In a further step of the embodiment of the second method according to the invention, the plates are removed from the mold. In an embodiment, the first plate is removed from the first mold and the second metal plate is removed from the second mold.

In an embodiment, at least one positioning feature is formed on the first metal plate and/or on the second metal plate. The at least one positioning feature on the first metal plate is formed during the pressing step, wherein the first metal plate is pressed to the first predetermined shape at the inner surface of the first mold.

Similarly, in an embodiment, at least one positioning feature on the second metal plate is formed during the pressing step, wherein the second metal plate is pressed to the second predetermined shape at the inner surface of the second mold. The at least one positioning feature is provided in the first and/or second predetermined shape at the inner surface of the first and/or second mold, respectively.

After the plates are removed from the first and second mold, the at least one positioning feature can be used for positioning the first metal plate and the second metal plate. The at least one positioning feature is adapted such that the first metal plate and the second metal plate can be properly arranged in a laser beam welding position inside a welding holding tool. The at least one positioning feature may e.g. be local grooves and/or positioning protrusions, which are manufactured at a predetermined location on the plates, e.g. at the corners of the plates.

Further, in an embodiment, the first metal plate and the second metal plate manufactured according to the second method are positioned according to the first method according to the invention. Thus, when the plates are manufactured according to the second method, the plates are transported to the laser welding tool. A possible additional step is to pre-cut the plates into desired dimensions. The pre-cutting of the plates may be performed before and/or after the second method. During the pre-cutting, the plates may e.g. arranged in a cutting jig.

In the laser welding tool, the plates are positioned relative to each other and relative to the laser welding machine by a positioning system. First, the positioning system comprises a welding holding tool, wherein the plates are arranged in a laser beam welding position. This arranging step can be performed manually or automatically, e.g. by a multi-axis robot arm. The laser welding tool further comprises at least one welding fixture and/or a suction force system to fix both plates relative to each other in the welding holding tool, when the plates are in the laser beam position. The laser welding machine comprises a laser source. The laser source radiates the welding bump on the first metal plate with a laser beam when the plates are fixed in the welding holding tool. The laser beam causes a weld between both plates.

The invention further relates to a first metal plate and a second metal plate as described below. The methods according to the invention may be performed with said first and second metal plate and/or to manufacture said first and second metal plate; however, neither the methods nor the first and second metal plate are limited thereto. Nevertheless, features and definitions explained with reference to the methods according to the invention may be interpreted similarly when mentioned in reference to the first and second metal plate, and vice versa. Furthermore, features and/or embodiments explained with reference to the method according to the invention may be added to the first and second metal plate according to the invention to achieve similar advantages, and vice versa.

In a third aspect, the invention further pertains to a first metal plate and a second metal plate being associated with the first metal plate. The first metal plate and the second metal plate are adapted to be joined together by laser beam welding, wherein:
the first metal plate comprises a first plate welding zone and a first surface, having a first channel structure, and a first opposite surface, having a first opposite channel structure,
the second metal plate comprises a second plate welding zone and a second surface, having a second channel structure, and a second opposite surface, having a second opposite channel structure, and wherein the second metal plate comprises no welding bump,
the first channel structure and the second channel structure are adapted to form a flow field channel pattern when the first metal plate and the second metal plate are joined together,
the first plate welding zone comprises a welding bump,
   wherein the welding bump is adapted to project towards the second plate welding zone of the second metal plate during a welding process wherein a laser beam is focused at the welding bump.

A first surface of the first metal plate has a first channel structure and a first opposite surface of the first metal plate has a first opposite channel structure. Likewise, a second surface of the second metal plate has a second channel structure and a second opposite surface of the second metal plate has a second opposite channel structure.

By joining the first surface of the first metal plate to the second surface of the second metal plate, the first channel structure and the second channel structure form a flow field channel pattern. Preferably, the flow field channel pattern serves for the flow of a coolant, which e.g. may be water, glycol, or a mixture. However, it is also possible that the flow field channel pattern servers for the flow of a reactant, e.g. hydrogen or oxygen.

For clarity reasons, as already explained above, the flow field channel pattern is referred to as the channel at an inside of the plates, i.e. when the first metal plate and the second metal plate are connected. However, the flow field channel pattern may also be located at an outside of the plates. Further note, that the first surface and the first opposite surface are interchangeable, meaning that the first surface or the first opposite surface may be located at the outside or at the inside of the plates. The same reasoning applies to the second surface and the second opposite surface of second metal plate.

When the first metal plate and the second metal plate are fixed, e.g. by the suction force system and/or the at least one welding fixture, the welding bump is projected towards the second plate welding zone of the second metal plate. In an embodiment, the welding bump has a curved shape having a radius of curvature. In an embodiment, the radius of curvature of the welding bump is 0.5-2.5 mm, preferably 0.75-1.5 mm, more preferably 0.8-1.2 mm. Due to the curved shape of the welding bump, an outer point of the welding bump is position out of plane of the first metal plate by a height of the welding bump. The curved shape of the welding bump ensures that the outer point of the welding bump contacts the second metal plate. Preferably, the radius of curvature is chosen to avoid that the curvature of the outer point of the welding bump has a steep slope. Preferably, the slope has an inclination of around 1-5%. This can be regarded as a relatively gentle slope. The slope according to this embodiment secures a broad contact between both plates. The broad contact realizes a satisfactory weld, which benefits the flatness of the plates. For example, the radius of curvature is greater than a height of the welding bump.

In an embodiment, the welding bump is deformable by being pressed against the second metal plate, such that the outer point of the welding bump is position out of plane of the first metal plate by a fixing distance, said fixing distance being smaller than the height of the bump before deformation.

To join the two plates together, a laser beam from a laser beam source can be focused at the welding bump. During the welding process, the welding bump ensures an improved contact between the first metal plate and the second metal plate.

In an embodiment, the welding bump is deformable by being heated above a melting point, e.g. by means of a laser beam when the first plate and second plate are being joined, such that the outer point of the welding bump is position out of plane of the first metal plate by a joined distance, said joined distance being smaller than the fixing distance and/or than the height of the bump before deformation. During such joining step, the welding bump is exposed to a laser beam. This generates heat. The welding bump is heated above the melting point. Consequently, the plates will melt locally, i.e. at the welding bump. The height of the welding bump will diminish. The effect is that the distance between the plates decreases. As a result, both plates are welded to each other by the welding bump with a minimal gap between the plates. Further, faults, e.g. due to bad contact of the plates or positioning faults, are not cumulated by stacking the plates. For example, during stacking of bipolar plates, hundreds of plates are stacked. This means that an error of a few μm would result in a worse quality stack, e.g. for use in fuel cells. For example, an unwanted sunken weld is mitigated by the invention.

Additionally, compared to conventional machines, the welding bump allows that the at least one welding fixture is positioned at greater distance from the weld, which ensures a diminished amount of splashes or debris on the welding tools and/or plates. This leads to a decrease of rework of the plates and an increased life time of the laser welding tool.

The process to manufacture the two plates depends on several aspects, e.g. the material of the plates, size of the plates etc. In an embodiment, the first metal plate and the second metal plate being associated with the first metal plate are manufactured by a deformation process, for example hydroforming, stamping or embossing. In practice, hydroforming is a reliable way of accurately forming the welding bump on the first metal plate.

In an embodiment, the height of the welding bump is less than 50 μm. In an embodiment, the height of the welding bump is 5-50 μm, preferably 10-30 μm, more preferably 15-25 μm.

In an embodiment, a width of the welding bump is 0.2-2 mm, preferably 0.3-1.5 mm, more preferably 0.4-1 mm.

In an embodiment, the welding bump of the first metal plate has an elongated shape and a length. Preferably, the welding bump is formed as a closed loop on the first metal plate.

Further, the first metal plate comprises a first plate welding zone and the second metal plate comprises a second plate welding zone. In an embodiment, the dimension of the first plate welding zone is at least as large as the dimension of the welding bump of the first metal plate. In an embodiment, the dimension of the first plate welding zone equals the dimension of the welding bump on the first metal plate.

In an embodiment, the dimension of the second plate welding zone is at least as large as the dimension of the welding bump on the first metal plate. In an embodiment, the dimension of the second plate welding zone equals dimension of the welding bump on the first metal plate. Preferably, the second plate welding zone completely overlaps the first plate welding zone, when the first metal plate and the second metal plate are positioned in the laser beam welding position. Said overlapping occurs in a plane being perpendicular to a height of the welding bump, e.g. in a horizontal plane.

In an embodiment, a thickness of each of the plates is 20-500 μm, preferably 25-250 μm, more preferably 50-100 μm. To prevent leakage at the location of the welds, it is preferred that the gap between the two plates is as small as possible. An interrupted, broken or defective weld of a few μm may already be sufficient to cause a leak.

In a further embodiment, the first metal plate and/or the second metal plate comprises at least one positioning feature. The at least one positioning feature is adapted for positioning the first metal plate and the second metal plate when the first metal plate and the second metal plate are being arranged in a laser beam welding position.

The positioning feature may e.g. be a local groove and/or a positioning protrusion, which is manufactured at a predetermined location on the plates, e.g. at the corners of the plates.

In an embodiment, the first metal plate and the second metal plate are adapted to be laser beam welded to each other at the first plate welding zone and the second plate welding zone. During the welding process, a laser beam is provided at the welding bump.

In an embodiment, the plates are manufactured according to the second method of the invention.

In a fourth aspect, the invention relates to a first metal plate and a second metal plate being associated with the first metal plate, wherein the first metal plate and the second metal plate are manufactured according to the method of the second aspect of the invention.

In a fifth aspect, the invention relates to a method for connecting a first metal plate and a second metal plate to each other, wherein
the first metal plate comprises a first plate welding zone and a first surface, having a first channel structure, and a first opposite surface, having a first opposite channel structure,
the second metal plate comprises a second plate welding zone and a second surface, having a second channel structure, and a second opposite surface, having a second opposite channel structure, and wherein second plate welding zone is formed by the part of the second metal plate that is to be connected to the first plate welding zone of the first plate,
the first channel structure and the second channel structure are adapted to form a flow field channel pattern when the first metal plate and the second metal plate are joined together,
the first plate welding zone comprises a welding bump, and the second plate welding zone does not comprise a welding bump,
   wherein the method comprises the following steps:
arranging the first metal plate and the second metal plate in a laser beam welding position, such that
   the first channel structure and the second channel structure are positioned to form the flow field channel pattern;
   the welding bump of the first metal plate is projecting towards the second plate welding zone of the second metal plate;
fixing the first metal plate and the second metal plate in the laser beam welding position by
   using at least one welding fixture, wherein the at least one welding fixture engages the first metal plate next to the first plate welding zone and/or the second metal plate next to the second plate welding zone, and/or
   reducing a pressure of air between the first metal plate and the second metal plate, thereby providing a suction force,
connecting the first plate welding zone and the second plate welding zone to each other by welding.

Optionally, the first plate welding zone and the second plate welding zone are connected to each other by laser beam welding.

Optionally, the second plate welding zone is or comprises a flat engagement surface, and the flat engagement surface is arranged to engage the welding bump of the first plate welding zone when the first metal plate and the second metal plate are fixed in the laser beam welding position. Optionally, the welding bump has a width, and the flat engagement surface has a width which is larger than the width of the welding bump. Optionally, the welding bump has a length, and the flat engagement surface has a length which is larger than the length of the welding bump.

In an embodiment of the fifth aspect of the invention, the welding bump has a curved shape having a radius of curvature, and an outer point of the welding bump is position out of plane of the first metal plate by a height of the welding bump. During the step of fixing the first metal plate and the second metal plate the welding bump is partially flattened, such that said first metal plate and second metal plate are positioned on a fixing distance of each other, said fixing distance being smaller than the height.

In an embodiment of the fifth aspect of the invention, the at least one welding fixture engages next to the first welding zone and/or the second welding zone.

In an embodiment of the fifth aspect of the invention, the at least one welding fixture engages the first metal plate and the second metal plate at a distance of at least 0.3 mm, preferably 0.5-0.8 mm from the center of the welding bump.

In an embodiment of the fifth aspect of the invention, at least one positioning feature comprised by the first metal plate and/or the second metal plate is used for positioning the first metal plate and the second metal plate during the step wherein the first metal plate and the second metal plate are arranged in the laser beam welding position.

In an embodiment of the fifth aspect of the invention, the method further comprises the step of joining the first metal plate and the second metal plate by laser beam welding, and a laser beam is focused at the welding bump.

In an embodiment of the fifth aspect of the invention, the welding bump has an elongated shape and a length.

In an embodiment of the fifth aspect of the invention, a height of the welding bump is 5-50 μm, preferably 10-30 μm, more preferably 15-25 μm.

In an embodiment of the fifth aspect of the invention, a width of the welding bump is 0.2-2 mm, preferably 0.3-1.5 mm, more preferably 0.4-1 mm.

In an embodiment of the fifth aspect of the invention, the method further comprises a step of making at least one welding fixture based on dimensions of the first metal plate and/or the second metal plate, and/or on the flow field channel pattern, and/or on the location of the welding bump on the first metal plate.

In an embodiment of the fifth aspect of the invention, the method further comprises a step of designing the plates, wherein dimensions of the welding bump are determined based on tolerances of dimensions of the first metal plate and/or the second metal plate, and/or on dimensions of the laser beam to be focused on the welding bump during the laser beam welding.

The fifth aspect of the invention further pertains to a combination of a first metal plate and a second metal plate which are connected to each other by the method according to the fifth aspect of the invention.

The invention will be described in more detail below with reference to the figures, in which in a non-limiting manner exemplary embodiments of the invention will be shown. The same reference numerals in different figures indicate the same characteristics in different figures.

In the figures:

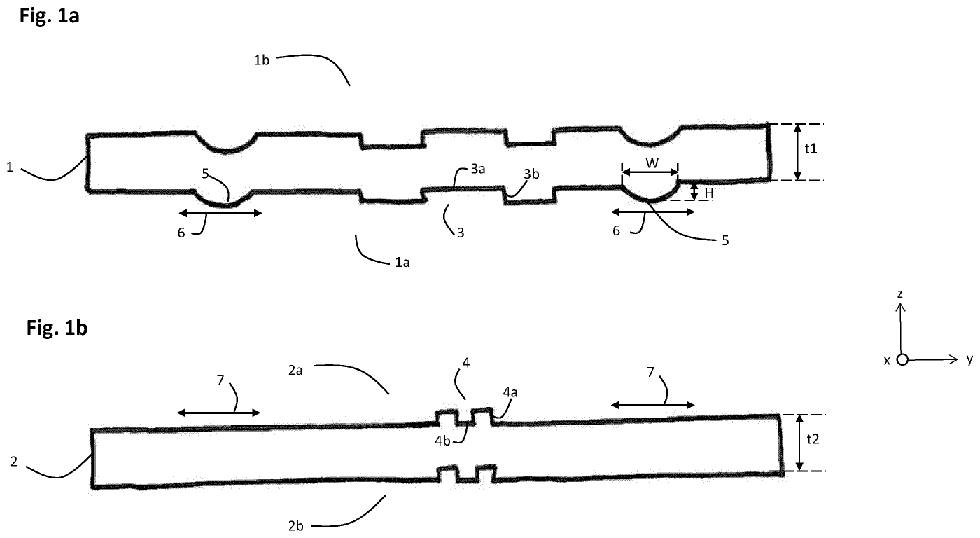

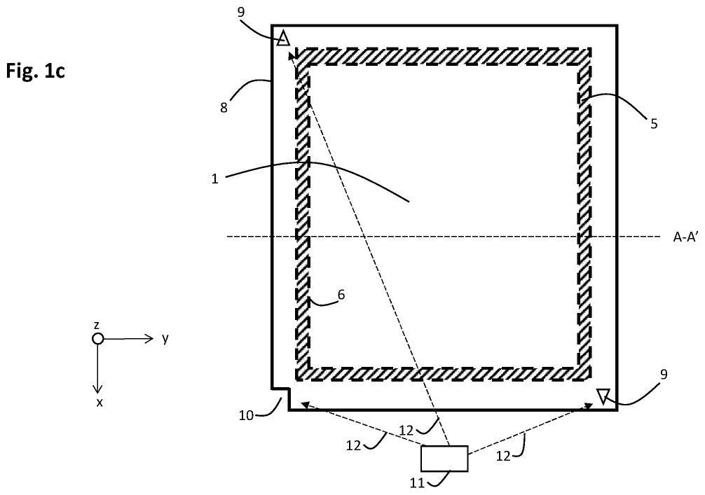

FIGS. 1a-1b: Schematically illustrate an example of a first metal plate and a second metal plate being associated with the first metal plate according to the invention;

FIG. 1c: Schematically illustrates a top view of the first metal plate with the welding bump on top of the second metal plate according to the invention;

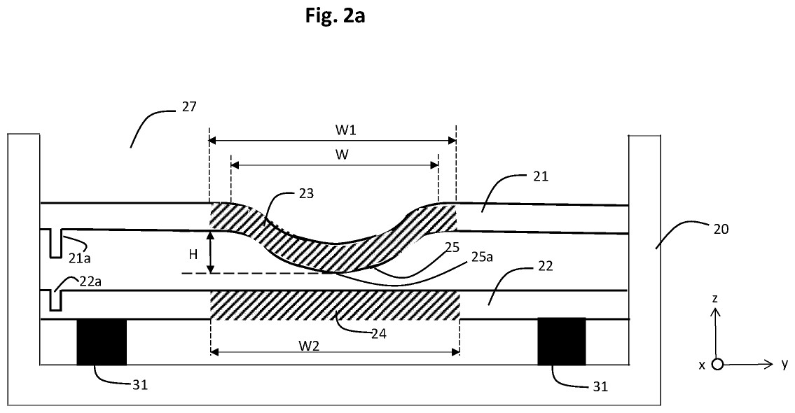

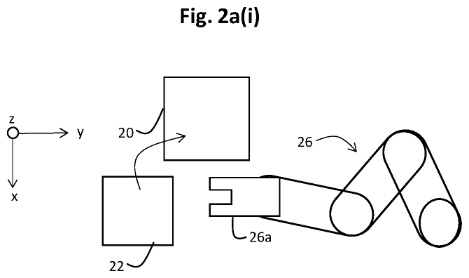

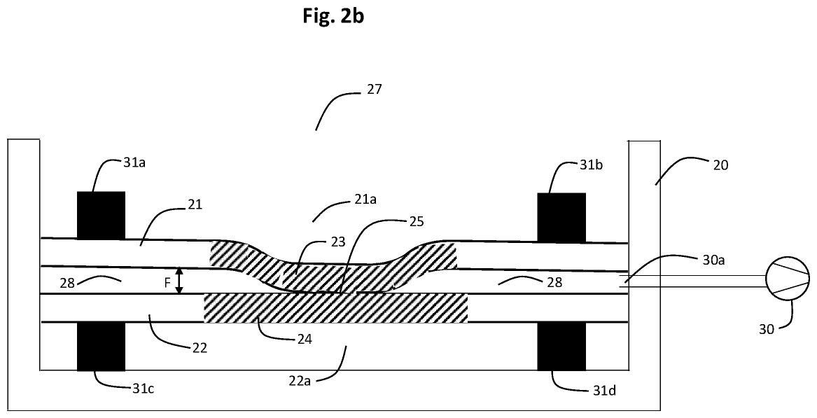

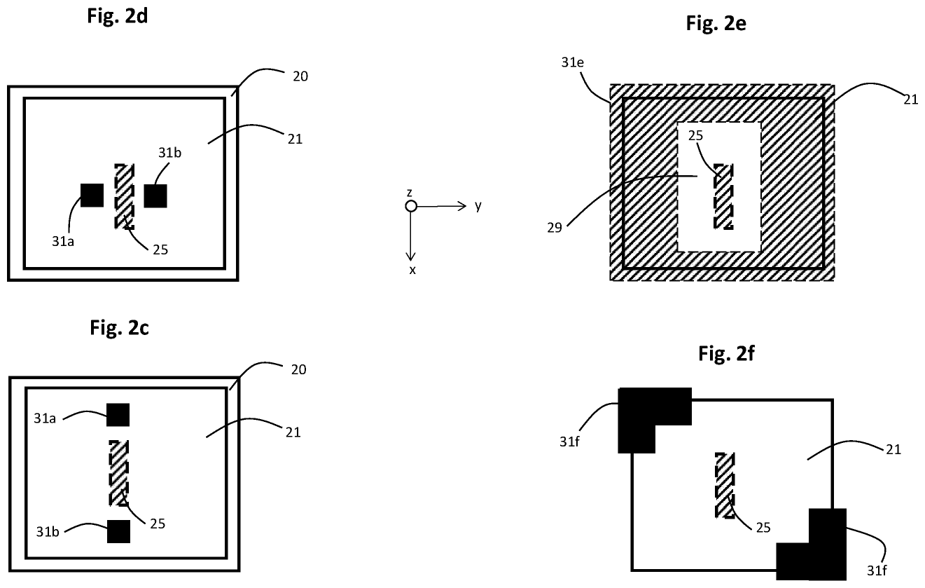

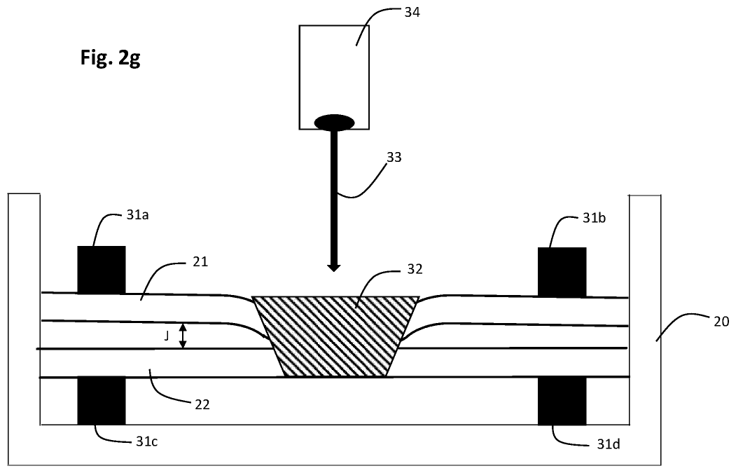

FIGS. 2a-2g: Schematically illustrate an embodiment according to the first method for positioning a first metal plate and a second metal plate relative to each other in a laser beam welding position according to the invention;

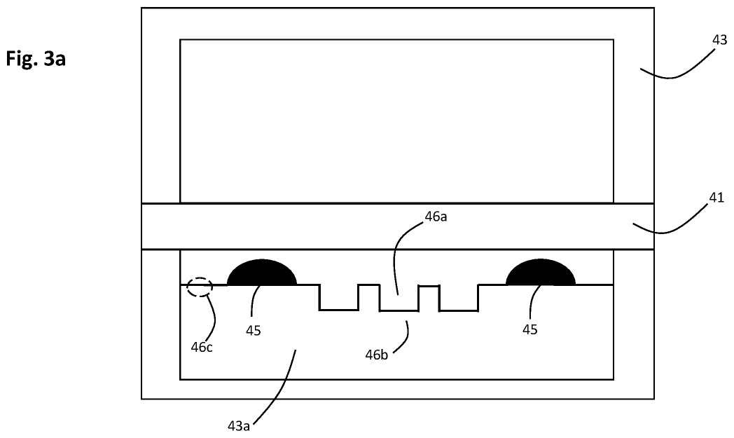

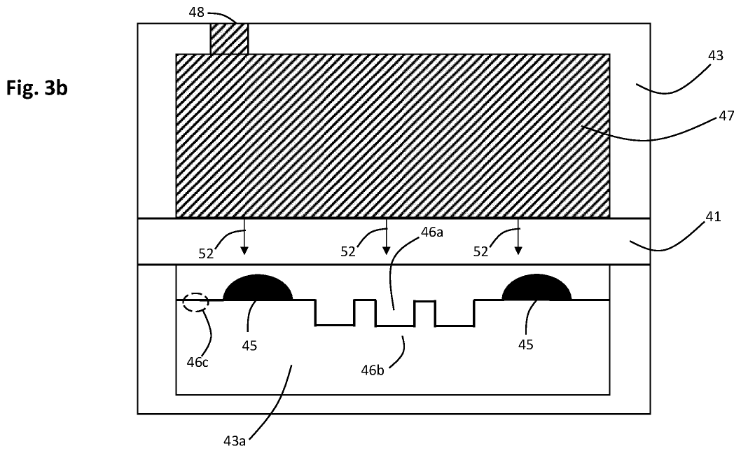

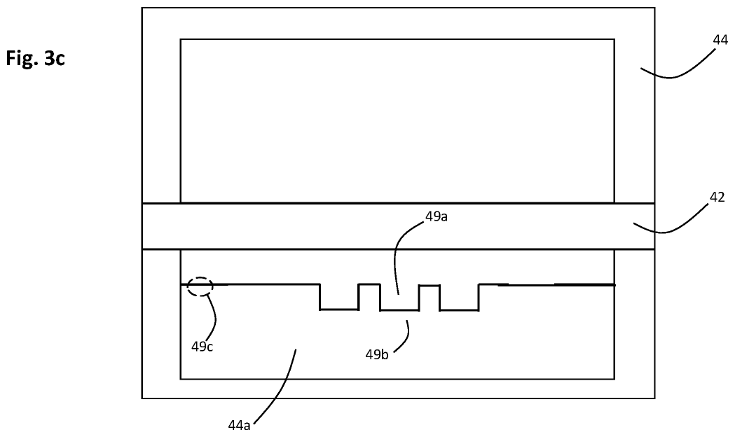

FIGS. 3a-3d: Schematically illustrate an embodiment according to the second method for manufacturing a first metal plate and a second metal plate associated with the first metal plate according to the invention.

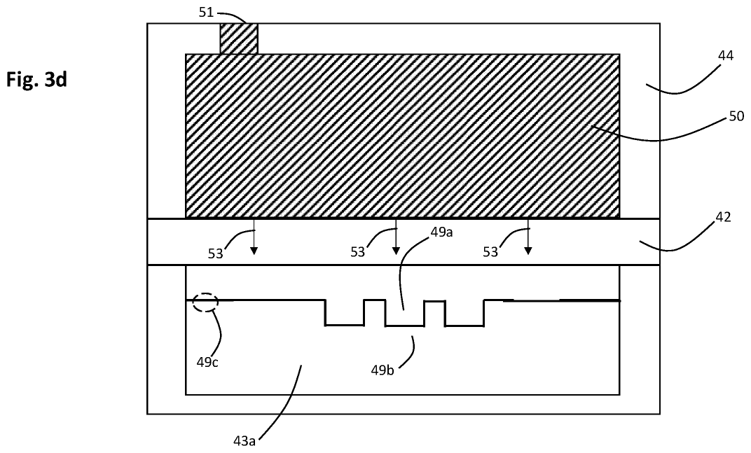

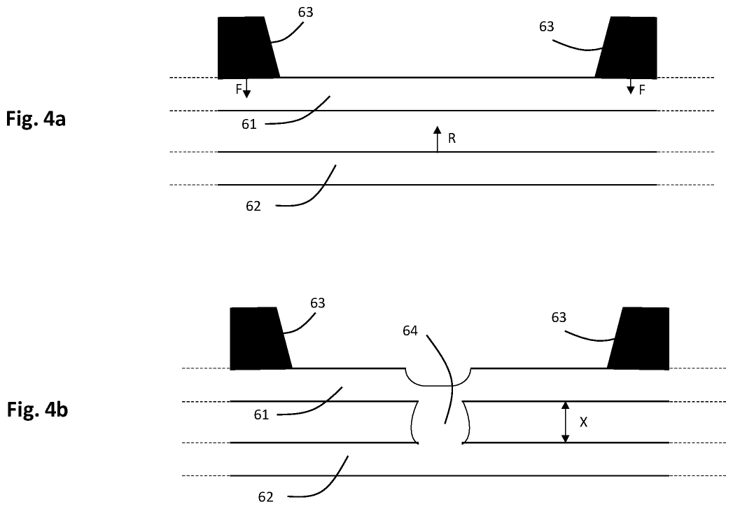

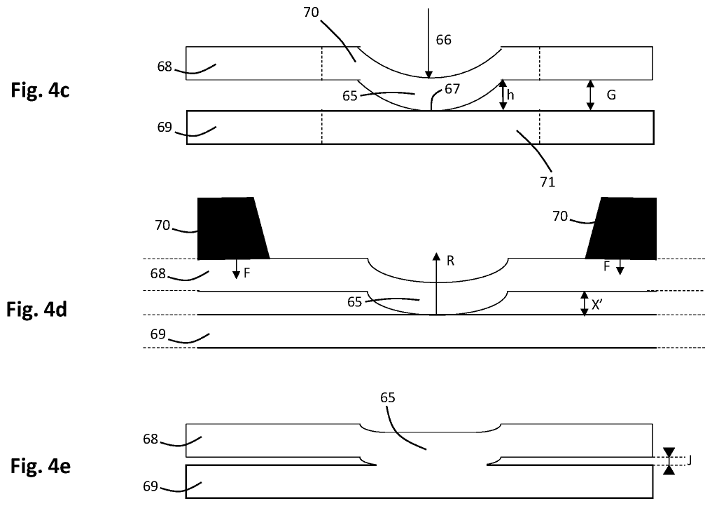

FIGS. 4a-e: Schematically illustrate a comparison between an embodiment with a welding bump according to the invention and a situation without a welding bump.

FIGS. 1a, 1b schematically illustrate an example of a cross-section of a first metal plate 1 and a cross-section of a second metal plate 2 being associated with the first metal plate 1 according to the invention.

The first metal plate 1 in FIG. 1a comprises a first surface 1a and a first opposite surface 1b. The first surface 1a of the first metal plate 1 has a first channel structure 3 and the first opposite surface 1b of the first metal plate 1 has a first opposite channel structure.

Likewise, the second surface 2a of the second metal plate 2 in FIG. 1b has a second channel structure 4 and the second opposite surface 2b of the second metal plate 2 has a second opposite channel structure.

By arranging the first channel structure 3 of the first metal plate 1 to the second channel structure 4 of the second metal plate 2, the first metal plate and the second metal plate are positioned, such that a flow field channel pattern is formed (not shown in FIGS. 1a, 1b). Preferably, the flow field channel pattern serves for the flow of a coolant, which e.g. may be water, glycol or a mixture.

Preferably, the first opposite channel structure of the first metal plate 1 is adapted to guide and divide a gaseous stream, e.g. hydrogen or oxygen, over the first opposite surface 1b. Preferably, the second opposite channel structure of the second metal plate 2 is to guide and divide a gaseous stream, e.g. oxygen or hydrogen, over the second opposite surface 2b.

In this example, the first channel structure 3 and the second channel structure 4 comprise protrusions, including alternately flat parts 3a, 4a and channel walls 3b, 4b. The first channel structure 3 optionally has the same design as the second channel structure 4.

Further, the first metal plate 1 has been provided with a first welding zone 6. In FIG. 1a, the first metal plate 1 has two welding bumps 5 and thus two first welding zones 6, which welding zones 6 are indicated by the double arrow. Note that the welding zones 6, 7, welding bump 5 and channel structures 3, 4 are not drawn to scale, but are for illustrative purposes. Similarly, the second metal plate 2 comprises two second welding zones 7. Each first plate welding zone 6 comprises a welding bump 5. The second metal plate 2 does not have a welding bump. Remark that in this example the two welding bumps 5 of the first metal plate in the cross-section of FIG. 1a actually originate from one closed welding bump 5 on the first metal plate 1, which is visualised in the top view of the first metal plate 1 in FIG. 1c. FIG. 1a shows intersection A-A′ along the y-axis.

The welding bump 5 of the first metal plate 1 is adapted to project towards the second plate welding zone 7 of the second metal plate 2 during a welding process wherein a laser beam from a laser beam source is focused at the welding bump 5.

In the shown embodiment, the width W of the welding bump 5 is 1 mm and the height H is 25 μm. However, other dimensions are possible. Taking into account the dimensions of the welding bump 5, the welding bump 5 comprises a slope, when seen in direction of the width, i.e. the y-direction. The slope has an inclination of around 5%. This can be regarded as a relatively gentle slope. The slope secures a broad contact between both plates (see FIG. 2b). The broad contact realizes a satisfactory weld, which benefits the flatness of the joined plates.

FIG. 1c shows a possible top view of the first metal plate 1 on top of the second metal plate according to the invention. The channel patterns are not shown for clarity reasons. In the embodiment, the welding bump 5 is indicated by the dashed region, wherein the welding bump 5 has an elongated shape and a length. In FIG. 1c, the welding bump 5 is formed as a closed loop on the first metal plate 1. For example, at a distance of 1 cm of an edge 8 of the first metal plate 1. Also, many other configurations are possible. In FIG. 1c, the welding bump 5 is projecting towards the underlying second metal plate, i.e. the welding bump is projected in the negative z direction.

As can be seen in FIG. 1a, a length and/or width (indicated by the double-sided arrow 6) of the first plate welding zone 6 is at least as large as a length and/or width W of the welding bump 5 of the first metal plate 1. In particular, the length and/or width of the first plate welding zone 6 equals the length and/or width W of the welding bump 5 on the first metal plate 1. In FIG. 1c the first plate welding zone 6 overlaps the dashed region.

As can further be seen in FIG. 1b, a length and/or width (indicated by the double-sided arrow 7) of the second plate welding zone 7 is at least as large as a length and/or width W of the welding bump 5 on the first metal plate 1. In particular, the length and/or width of the second plate welding zone 7 equals the length and/or width W of the welding bump 5 on the first metal plate 1. Preferably, the second plate welding zone 7 matches the first plate welding zone 6, when the first metal plate 1 and the second metal plate 2 are positioned in a laser beam welding position.

Additionally, a thickness of each of the plates is 20-200 μm, more preferably 50-100 μm. For example, in FIGS. 1a,1b, the thickness t1 of the first metal plate 1 is 100 μm and the thickness t2 of the second metal plate 2 is 50 μm. Alternatively, both thicknesses are equal. To prevent leakage at the location of the welds, it is important that the gap between the two plates is as small as possible. An interrupted, broken or defective weld of a few μm may already be sufficient to have a leak.

The embodiment of FIGS. 1a-c can for example be positioned according to a first method in accordance to the invention and/or manufactured according to a second method in accordance to the invention. These methods will be explained below. In an embodiment, the first metal plate and the second metal plate are formed by hydroforming.

Additionally, the first metal plate 1 and/or the second metal plate 2 comprises at least one optional positioning feature 9, 10, visible in FIG. 1c. The at least one positioning feature 9, 10 can for example be a protrusion or an aperture in the plates to connect the two plates mechanically, see for example the aperture 10 of the first metal plate 1 in FIG. 1c. Note that the underlying second metal plate 2 may have the identical aperture 10 as the first metal plate. Another example may e.g. be the produced pattern 9 at two corners of the first metal plate 1. The positioning features 9, 10 can be detected by a positioning sensor 11, e.g. a sensing camera, which emits and receives a measurement signal 12. Similar, an additional second produced pattern may be produced on the second metal plate 2 (not shown). Depending on the pattern, the positioning sensor 11 can determine the position of the first metal plate 1 and/or the second metal plate 2 to arrange the plates in a laser beam welding position.

FIG. 2a shows an embodiment according to the first method for positioning a first metal plate 21 and a second metal plate 22 relative to each other in a laser beam welding position according to the invention.

First, the first metal plate 21 and the second metal plate 22 are arranged in a laser beam welding position. This step can be performed manually or automatically, e.g. by a pick-and-place robot or a multi-axis robot arm. For example, as shown in the top view in FIG. 2a(i), a multi-axis robotic arm 26 picks with a gripper 26a one of the two plates, e.g. the second metal plate 22, and places the second metal plate 22 in a welding holding tool 20. Thereafter, at least one positioning sensor (not shown in FIG. 2a) scans the second metal plate 22 to determine the position of the second metal plate 22 inside the welding holding tool 20. Depending on the position of the second metal plate 22 inside the welding holding tool 20, the robotic arm 26 is able to arrange the other plate, e.g. the first metal plate 21, at the correct location on top of the second metal plate 22 inside the welding holding tool 20. For example, the first metal plate 21 and the second metal plate 22 comprise a positioning feature. The positioning feature 21a of the first metal plate 21 in FIG. 2a is a protrusion. The second metal plate 22 has an aperture 22a, wherein the protrusion 21a of the first metal plate 21 can be fitted inside the aperture 22a of the second metal plate 22. The positioning features 21a, 22a ensure that the plates are connected mechanically. However, other configurations are possible. The plates may also be placed together or simultaneously inside the welding holding tool 20.

The welding holding tool 20 is a part of the positioning system 27 of the laser welding tool. To fix the first metal plate 21 and the second metal plate 22 relative to each other in the laser beam welding position, the positioning system 27 further comprises at least one welding fixture 31 and/or a suction force system. This will be explained below.

The first plate welding zone 23 and the second plate welding zone 24 are indicated by the dashed regions in FIG. 2a. The first plate welding zone 23 comprises a welding bump 25, which is projected towards the second plate welding zone 24 of the second metal plate 22. A length and/or width W1 of the first plate welding zone 23 is at least as large as a length and/or width W of the welding bump 25 of the first metal plate 21. In the shown embodiment, the length and/or width W1 of the first welding zone 23 is larger than the length and/or width W of the welding bump 25 on the first metal plate 21. Preferably, the length and/or width of the first welding zone 23 equals the length and/or width of the welding bump 25. Note that the lengths are oriented along the x-axis (see the indicated xyz coordinate system).

Further, a length and/or width W2 of the second plate welding zone 24 is at least as large as a length and/or width W of the welding bump 25 on the first metal plate 21. In the shown embodiment, the first welding zone 23 and the second welding zone 24 are equal in length and/or width. The first 25 and second welding zones 23 are overlapping in a plane being perpendicular to a height of the welding bump, i.e. xy-plane, in the laser beam welding position.

The welding bump 25 has a curved shape having a radius of curvature. Due to the curved shape of the welding bump 25, an outer point 25a of the welding bump is position out of plane of the first metal plate 21 by a height H of the welding bump 25. The radius of curvature is greater than the height H of the welding bump 25.

During the arranging step, the first channel structure and the second channel structure are positioned to form the flow field channel pattern. Said flow field channel pattern 28 is indicated in FIG. 2b. In addition, the welding bump 25 of the first metal plate 21 is projecting towards the second plate welding zone 24 of the second metal plate 22.

Additionally, the plates are designed taking into account their functionality and material characteristics. The dimensions of the welding bump 25 on the first metal plate 21 are determined based on tolerances of dimensions of the first metal plate 21 and/or the second metal 22, and/or on dimensions of the laser beam to be focused on the welding bump 25 during the laser beam welding.

In the next step in FIG. 2b, two welding fixtures 31a, 31b engage the first metal plate 22 next to the first plate welding zone 23, while two welding fixtures 31c, 31d contact the second metal plate 22 next to the second plate welding zone 24. Note that the positioning features 21a, 22a have been left out for clarity. Additionally, the fixing of the plates can be assisted by providing a suction force. The suction force is provided by a suction force system 30, e.g. comprising a compressor. The suction force system 30 is configured to reduce the pressure of air at an inlet 30a between the first metal plate 21 and the second metal plate 22. Remark that the fixing by at least one welding fixture and by the suction force are complementary to each other. For example, when the plates have flat surfaces and the plates are very well positioned, either one of the suction force or at least one welding fixture may be sufficient to fix the plates. However, in the following figures it is assumed that both vacuum and at least one welding fixture are applied.

During the fixing step of the first metal plate 21 and the second metal plate 22 according to this embodiment, the welding bump 25 is partially flattened. The welding bump 25 is pressed against the second plate welding zone 24 of the second metal plate 22. The welding bump 25 deforms as a result of the fixing step, leading to a reduced height of the welding bump 25. In this manner, the first metal plate 21 and the second metal plate 22 are positioned on a fixing distance F of each other. The fixing distance F is smaller than the height of the welding bump 25.

The four welding fixtures 31a, 31b, 31c, 31d in FIG. 2b are made based on dimensions of the first metal plate 21 and/or the second metal plate 22, and/or on the flow field channel pattern 28, and/or on the location of the welding bump 25 on the first metal plate 21. In FIG. 2b, two welding fixtures 31a, 31b engage the first metal plate 21 next to the first welding zone 23 and two welding fixtures 31c, 31d engage the second metal plate 22 next to the second welding zone 24.

For example, the at least one welding fixture may e.g. be a fixture clamp, as illustrated in FIG. 2b. In FIG. 2b, four fixture clamps clamp both plates together. A first fixture clamp 31a and a second fixture clamp 31b are arranged at the first opposite surface 21a of the first metal plate 21, thus at the opposite side of the welding bump 25. A third fixture clamp 31c and a fourth fixture clamp 31d are arranged at the second opposite surface 22a of second metal plate 22. Preferably, the first fixture clamp 31a is positioned parallel relative to second and third fixture clamps 31b, 31c. Similarly, the fourth fixture clamp 31d is positioned parallel relative to second and third fixture clamps 31b, 31c.

As can be seen in FIG. 2b, both plates are arranged in the welding holding tool 20 and the first welding fixture 31a and the second welding fixture 31b engage the first metal plate 21. The laser beam from the laser beam source (shown in FIG. 2g) of the laser welding machine is moving in the direction from one of the two fixture clamps 31a, 31b towards the other of the two fixture clamps 31a, 31b during welding (see the top view of FIG. 2c). In another possible embodiment, the laser beam is moving between the two fixture clamps 31a, 31b during the welding process (see the top view of FIG. 2d).

Another example to fix both plates 21, 22, is that the at least one welding fixture 31e, 31f may e.g. be a structure, which is cut in a predetermined shape. Due to the weight of the structure 31e, 31f and/or gravity both plates 21, 22 are fixed, when the structure 31e, 31f engages one of the two plates 21, 22. When the plates 21, 22 are fixed, the welding bump 25 remains accessible, e.g. by an opening 29 in the predetermined shape of the structure 31e, for the laser beam. Hence, the laser beam from the laser beam source is able to radiate the right location, i.e. the welding bump 25 on the first metal plate 21. Further, at least the welding bump 25 of the first metal plate 21 makes contact with the second welding zone 24. Examples of predetermined shapes of the welding fixtures are shown in the top views of FIGS. 2e-2f. A welding fixture is placed on top of the first metal plate 21, wherein the first metal plate 21 comprises the welding bump 25.

In FIG. 2e, the predetermined shape of a welding fixture 31e (dashed region) is a plate 31e, which plate 31e comprises a rectangular opening 29 in the middle. Therefore, the welding bump 25 remains accessible for the laser beam. FIG. 2f shows two welding fixtures 31f, which are arranged at the corners of the first metal plate 21.

Moreover, different combinations of welding fixtures may be applied.

The welding fixtures 31a, 31b, 31c, 31d, 31e, 31f ensure contact between the first metal plate 21 and the second metal plate 22, by pressing them together. In addition, the suction force assists the contacting between the plates. In accordance with the present invention, the welding bump 25 contributes to ensuring contact between the first metal plate 21 and the second metal plate 22. The exact positions of the welding fixtures 31a, 31b, 31c, 31d, 31e, 31f to engage the plates 21, 22 according to the invention are less important relative to conventional machines/systems, which gives an enhanced flexibility during operation and allows to make less accurate welding tools, reducing the overall costs. Further, the welding bump 25 on the first metal plate 21 allows that the welding fixtures 31a, 31b, 31e, 31f are positioned at a greater distance from the location where the laser beam is projected during the welding process. Therefore, the distances of the welding fixture 31a, 31b, 31e, 31f relative to the welding bump 25 ensure a diminished amount of splashes or debris on the laser welding tools and/or plates 21, 22 during laser welding. This leads to a decrease of rework of the plates 21, 22 and an increased lifetime of the laser welding tools.

Additionally, a gap between the fixed plates is smaller than 5 percent, preferably 5 percent, more preferably 3 percent, for example 0 percent of the thickness of each of the plates at the location of the welding bump 25. For example, the thickness of each of the plates is 20-500 μm, preferably 25-250 μm, more preferably 50-100 μm. To weld the two plates, the gap have to be minimal. A too large offset will lead to laser cutting of the plates instead of laser welding. Suppose that each plate has a thickness of 100 μm, the gap between the two plates preferably is no more than 5 μm at the location of the weld. The welding bump 25 ensures an improvement in contact between the two plates. Hence, this will lead to an enhancement in accuracy of the weld.

In FIG. 2g, after the first metal plate 21 and the second metal plate 22 are fixed by vacuum and the first, second, third and fourth welding fixtures 31a, 31b, 31c, 31d, the two plates 21, 22 are joined by laser beam welding, wherein a laser beam 33 is focused at the welding bump 25. The laser beam 33 is radiated by a laser beam source 34 to generate a weld 32. The laser beam source 34 is e.g. a part of the laser welding tool. The weld 32 is visualised by the dashed region. The weld 32 extends over the entire length of the welding bump (not visible in FIG. 2g). It is noted that FIG. 2g shows a schematic simplification of the laser welding tool. In practice, a lens system may be provided to direct the laser beam 33 from the laser beam source 34 onto the two plates 21, 22. A 2D positioning table may be provided to move the lens system.

During the step of joining the first metal plate 21 and the second metal plate 22, the welding bump 25 is at least partially melted by the laser beam 33. After the step of joining the first metal plate second metal plate, the first metal plate 21 and second metal plate 22 are positioned on a joined distance J of each other, said joined distance J being smaller than fixing distance F. As a result, both plates 21, 22 are welded to each other by the welding bump 25 with a smaller gap, i.e. joined distance J, between the plates 21, 22.

FIGS. 3a-3d schematically illustrate an embodiment for manufacturing a first metal plate 41 and a second metal plate 42 according to the second method according to the invention. Again note that the figures and features are not drawn to scale, but are for illustrative purposes. In the second method according to the invention, a first 43 and a second mold 44 are used to deform the plates 41, 42. The deformation process may for example be hydroforming, stamping or embossing. In practice, hydroforming is applied, because this process ensures the accurate forming of the welding bump 45 on the first metal plate 41. The first 43 and the second 44 mold may e.g. be a chamber with a predetermined shape 43a, 44a at an inner surface, e.g. at the bottom. The predetermined shape 43a, 44a depends on several factors, for instance on the location of the welding bump 45 on the first metal plate 41 and/or the dimensions of the two plates.

In FIGS. 3a-3d, a first metal plate 41 (FIGS. 3a-3b) and a second metal plate 42 (FIGS. 3c-3d) are arranged inside different molds 43, 44, respectively the first mold 43 and the second mold 44. The two plates 41, 42 can be arranged simultaneously or not. Also, other arrangements are possible, for example that the first metal plate 41 and the second metal plate 42 are arranged simultaneously in a single mold structure, which single mold structure comprises two separated compartments. Each plate 41, 42 is then arranged in a different compartment. The compartments may be parallel to each other.

In the embodiment according to FIGS. 3a-d, the two plates are manufactured in different molds 43, 44 and not simultaneously, e.g. at different times and/or locations. The first metal plate 41 is arranged inside a first mold 43. The first mold 43 has a first predetermined shape 43a at an inner surface, e.g. at the bottom. The first predetermined shape 43a includes a structure of a welding bump 45 and a first channel structure 46a and a first opposite channel structure 46b. Additionally, the first predetermined shape 43a further comprises a structure of at least one positioning feature 46c, e.g. a protrusion.

When the first metal plate 41 is arranged in the first mold 43, the second method according to the invention further comprises the injection of a first fluid 47 at a first injection pressure into the first mold 43 (see FIG. 3b). The first fluid 47 is injected via an inlet 48 of the first mold 43. Depending on the type, dimensions and material of the first metal plate 41, the first injection pressure inside the first mold 43 can be between 500-5000 bar, preferably between 1000-3000 bar, more preferably between 1200-2000 bar.

In FIG. 3b, due to the first injection pressure, the first fluid 47 presses (indicated by the arrows 52) the first metal plate 41 to the first predetermined shape 43a at the inner surface of the first mold 43. Because of the pressing force, the first predetermined shape 43a deforms the first metal plate 41. This causes first channel structure 46a and a first opposite channel structure 46b and a welding bump 45 on the first metal plate. For example, the result may be the deformed first metal plate 1 according to FIG. 1a. Additionally, the at least one positioning feature 46c can be formed on the first metal plate 41 during the pressing step.

After the pressing step, the pressure inside the first mold 43 is reduced to ambient pressure. Thereafter, the first metal plate 41 is removed from the first mold 43 and immersed in a water basin to cool and rinse the plate.

Analogous, the second metal plate 42 is arranged inside a second mold 44 with a second predetermined shape at an inner surface (see FIG. 3c). The second predetermined shape 44a includes a structure of a second channel structure 49a and a second opposite channel structure 49b. Additionally, the second predetermined shape 44a further comprises the structure of at least one positioning feature 49c, e.g. an opening. In an embodiment, the first channel structure 46a and second channel structure 49a are the same.

Similarly, the second metal plate 42 is pressed to the second predetermined shape 44a at the inner surface of the second mold 44 by injecting a second fluid 50 at a second injection pressure, e.g. water, into the mold (see FIG. 3d). The second fluid 50 is injected via an inlet 51 of the second mold 44. Depending on the type, dimensions and material of the second metal plate 42, the second injection pressure inside the second mold 44 can be between 500-5000 bar, preferably between 1000-3000 bar, more preferably between 1200-2000 bar.

Because of the pressing force (indicated by the arrows 53 in FIG. 3d), the second predetermined shape 44a deforms the second metal plate 42. This step causes the second channel structure 49a and the second opposite channel structure 49b on the second metal plate 42. No welding bump is manufactured on the second metal plate 42. For example, the result may be the deformed second metal plate 2 according to FIG. 1b. Additionally, at least one positioning feature 49c on the second metal plate 42 is formed during the pressing step, wherein the second metal plate 42 is pressed to the second predetermined shape 44a at the inner surface of the second mold 44.

After the pressing step, the pressure inside the second mold 44 is reduced to ambient pressure. Similarly, the second metal plate 42 is removed from the second mold 44 and immersed in a water basin to cool and rinse the plate.

The manufactured first channel structure and the second channel structure are adapted to form a flow field channel pattern when the first metal plate 41 and the second metal plate 42 are joined together. The joined plates can serve as bipolar plates, for example in fuel cell applications, in particular for in a vehicle. When the bipolar plates are used in fuel cells, the chemical reaction between hydrogen and oxygen produces heat. Therefore, preferably, the flow field channel pattern is used to cool the plates by the flow of a coolant, which e.g. may be water, glycol or a mixture.

The manufactured positioning features 46c, 49c are used for positioning the first metal plate 41 and the second metal plate 42 when the first metal plate 41 and the second metal plate 42 are arranged in a laser beam welding position. The positioning features 46c, 49c are designed such that the first metal plate 41 and the second metal plate 42 are properly aligned. The positioning features 46c, 49c may e.g. be local grooves and/or positioning protrusions, which are manufactured at a predetermined location on the plates, e.g. at the corners of the plates.

Further, in an embodiment, the first metal plate 41 and the second metal plate 42 manufactured according to the second method are positioned according to the first method according to the invention.

FIGS. 4a-e illustrate the effect of a welding bump. In FIGS. 4a-b, a situation according to the prior art is illustrated, wherein the first metal plate 61 does not comprise a welding bump. In practice, the first metal plate 61 and a second metal plate 62 do not perfectly align before they are welded together, e.g. due to variation of the thickness of the plates 61, 62 within the manufacturing tolerances. This may cause some parts of the plates to be in contact while other are not. FIG. 4a shows a part of the plates 61, 62 where there is no contact. The stiffness of the plates may prevent the force F exerted by the welding fixtures 63 to deform the plates enough to cause to contact between the plates. Therefore, the reaction force R is practically zero. During the fixing step, there is no contact locally between the plates at the location of the weld. The result is a fixing distance X between the plates 61, 62.

As a consequence, welding of the plates leads to a worse quality weld or leakage problems. For example, if the fixing distance X is too large, no weld between the plates can be made. Even if a weld can be made, this may be an inferior weld, e.g. a sunken weld 64 such as shown in FIG. 4b. Furthermore, the fixing distance X will be same for every two plates manufactured with the same molds. This error will therefore accumulate when a large number of these plates are arranged in a fuel stack.

To at least mitigate these issues of the prior art, in FIGS. 4c-d an embodiment with a welding bump 65 according to the invention is shown. In FIG. 4c, the welding bump 65 has a curved shape having a radius of curvature 66. Due to the curved shape of the welding bump 65, an outer point 67 of the welding bump 65 is position out of plane of a first metal plate 68 by a height h of the welding bump 65. The curved shape of the welding bump 65 ensures that the outer point 67 of the welding bump 65 contacts a second metal plate 69 during the positioning step of the method according to the invention. By providing the welding bump 65, a gap G between the plates 68, 69 adjacent to welding zones 70, 71 will initially be created. The welding zones 70, 71 of the plates 68, 69 are delimited in between the vertical dotted lines. Preferably, the radius 66 of curvature is chosen to avoid that the curvature of the outer point 67 of the welding bump 65 has a steep slope. Preferably, the slope has an inclination of around 1-5%. This can be regarded as a relatively gentle slope. The slope according to this embodiment secures a broad contact between both plates. The broad contact realizes a satisfactory weld, which benefits the flatness of the plates. For example, the radius 66 of curvature is greater than a height h of the welding bump 65.

During the fixing step in FIG. 4d of the first metal plate 68 and the second metal plate 69 by the welding fixtures 70 according to the method according to the invention, the welding bump 65 is pressed against the second metal plate 69. Consequently, a line or surface contact is created. The welding fixtures 70 exert a clamping force F on both plates 68, 69 during the fixing step. As a consequence, a reaction force R is generated. Due to the spring-like behavior of the welding bump 65, the shape of the welding bump 65 deforms. The welding bump 65 partially flattens. In this manner, the first metal plate 68 and the second metal plate 69 are positioned on a fixing distance X′ of each other. The fixing distance X′ is smaller than the height h.

In FIG. 4e, during laser welding, the center of the welding bump 65 is exposed to a laser beam 65. This generates heat. The welding bump 65 is heated above the melting point. Consequently, the plates 68, 69 will melt locally, i.e. at the welding bump 65. The welding bump 65 is deformed. The effect is that the distance between the plates 68, 69 decreases to a joined distance J. As a result, both plates 68, 69 are welded to each other by the contact of the welding bump 65 with a small joined distance J between the plates 68, 69. Further, faults, e.g. due to bad contact of the plates or positioning faults, are not cumulated by stacking the plates. For example, during stacking of bipolar plates, hundreds of plates are stacked. This means that an error of a few μm would result in a worse quality stack, e.g. for use in fuel cells.

As required, this document describes detailed embodiments of the present invention. However it must be understood that the disclosed embodiments serve exclusively as examples, and that the invention may also be implemented in other forms. Therefore specific constructional aspects which are disclosed herein should not be regarded as restrictive for the invention, but merely as a basis for the claims and as a basis for rendering the invention implementable by the average skilled person.

Furthermore, the various terms used in the description should not be interpreted as restrictive but rather as a comprehensive explanation of the invention.

The word “a” used herein means one or more than one, unless specified otherwise. The phrase “a plurality of” means two or more than two. The words “comprising” and “having” are constitute open language and do not exclude the presence of more elements.

Reference figures in the claims should not be interpreted as restrictive of the invention. Particular embodiments need not achieve all objects described.

The mere fact that certain technical measures are specified in different dependent claims still allows the possibility that a combination of these technical measures may advantageously be applied.

1. A method for positioning a first metal plate and a second metal plate relative to each other in a laser beam welding position, wherein:
the first metal plate comprises a first plate welding zone and a first surface, having a first channel structure, and a first opposite surface, having a first opposite channel structure,
the second metal plate comprises a second plate welding zone and a second surface, having a second channel structure, and a second opposite surface, having a second opposite channel structure, and wherein the second metal plate comprises no welding bump,
the first channel structure and the second channel structure are adapted to form a flow field channel pattern when the first metal plate and the second metal plate are joined together,
the first plate welding zone comprises a welding bump,
wherein the method comprises the following steps:
arranging the first metal plate and the second metal plate in a laser beam welding position, such that:
the first channel structure and the second channel structure are positioned to form the flow field channel pattern; and
the welding bump of the first metal plate is projecting towards the second plate welding zone of the second metal plate;
fixing the first metal plate and the second metal plate in the laser beam welding position by:
using at least one welding fixture, wherein the at least one welding fixture engages the first metal plate next to the first plate welding zone and/or the second metal plate next to the second plate welding zone, and/or
reducing a pressure of air between the first metal plate and the second metal plate, thereby providing a suction force.

2. The method according to claim 1, wherein the welding bump has a curved shape having a radius of curvature, and wherein an outer point of the welding bump is position out of plane of the first metal plate by a height of the welding bump,
wherein during the step of fixing the first metal plate and the second metal plate the welding bump is partially flattened, such that said first metal plate and second metal plate are positioned on a fixing distance of each other, said fixing distance being smaller than the height.

3. The method according to claim 1, wherein the at least one welding fixture engages next to the first welding zone and/or the second welding zone.

4. The method according to claim 1, wherein the at least one welding fixture engages the first metal plate and the second metal plate at a distance of at least 0.3 mm, preferably 0.5-0.8 mm from the center of the welding bump.

5. The method according to claim 1, wherein at least one positioning feature comprised by the first metal plate and/or the second metal plate is used for positioning the first metal plate and the second metal plate during the step wherein the first metal plate and the second metal plate are arranged in the laser beam welding position.

6. The method according to claim 1, further comprising the step of joining the first metal plate and the second metal plate by laser beam welding, wherein a laser beam is focused at the welding bump.

7. The method according to claim 1, wherein the welding bump has an elongated shape and a length.

8. The method according to claim 1, wherein a height of the welding bump is 5-50 μm, preferably 10-30 μm, more preferably 15-25 μm.

9. The method according to claim 1, wherein a width of the welding bump is 0.2-2 mm, preferably 0.3-1.5 mm, more preferably 0.4-1 mm.

10. The method according to claim 1, wherein the method further comprises a step of making at least one welding fixture based on dimensions of the first metal plate and/or the second metal plate, and/or on the flow field channel pattern, and/or on the location of the welding bump on the first metal plate.

11. The method according to claim 1, wherein the method further comprises a step of designing the plates, wherein dimensions of the welding bump are determined based on tolerances of dimensions of the first metal plate and/or the second metal plate, and/or on dimensions of the laser beam to be focused on the welding bump during the laser beam welding.

12. A first metal plate and a second metal plate being associated with the first metal plate adapted to be joined together by laser beam welding, wherein:
the first metal plate comprises a first plate welding zone and a first surface, having a first channel structure, and a first opposite surface, having a first opposite channel structure,
the second metal plate comprises a second plate welding zone and a second surface, having a second channel structure, and a second opposite surface, having a second opposite channel structure, and wherein the second metal plate comprises no welding bump,
the first channel structure and the second channel structure are adapted to form a flow field channel pattern when the first metal plate and the second metal plate are joined together,
the first plate welding zone comprises a welding bump,
wherein the welding bump is adapted to project towards the second plate welding zone of the second metal plate during a welding process wherein a laser beam is focused at the welding bump.

13. The first metal plate and a second metal plate being associated with the first metal plate according to claim 12, wherein the welding bump has a curved shape having a radius of curvature, and wherein an outer point of the welding bump is position out of plane of the first metal plate by a height,
wherein during the step of fixing the first metal plate and the second metal plate the welding bump is partially flattened, such that said first metal plate and second metal plate are positioned on a fixing distance of each other, said fixing distance being smaller than the height.

14. The first metal plate and a second metal plate being associated with the first metal plate according to claim 12, wherein the first metal plate and the second metal plate are formed by hydroforming.

15. The first metal plate and a second metal plate being associated with the first metal plate according to claim 12, wherein the welding bump has an elongated shape and a length.

16. The first metal plate and a second metal plate being associated with the first metal plate according to claim 12, wherein a height of the welding bump is 5-50 μm, preferably 10-30 μm, more preferably 15-25 μm.

17. The first metal plate and a second metal plate being associated with the first metal plate according to claim 12, wherein a width of the welding bump is 0.2-2 mm, preferably 0.3-1.5 mm, more preferably 0.4-1 mm.

18. The first metal plate and a second metal plate being associated with the first metal plate according to claim 12, wherein the first metal plate and/or the second metal plate comprise at least one positioning feature, which at least one positioning feature is adapted to position the first metal plate and the second metal plate in a laser beam welding position.

19. The first metal plate and a second metal plate being associated with the first metal plate according to claim 12, wherein the first metal plate and the second metal plate are laser beam welded to each other at the first plate welding zone and the second plate welding zone, wherein a laser beam weld is provided at the welding bump.

20. A method for connecting a first metal plate and a second metal plate to each other, wherein:
the first metal plate comprises a first plate welding zone and a first surface, having a first channel structure, and a first opposite surface, having a first opposite channel structure,
the second metal plate comprises a second plate welding zone and a second surface, having a second channel structure, and a second opposite surface, having a second opposite channel structure, and wherein second plate welding zone is formed by the part of the second metal plate that is to be connected to the first plate welding zone of the first plate,
the first channel structure and the second channel structure are adapted to form a flow field channel pattern when the first metal plate and the second metal plate are joined together, and
the first plate welding zone comprises a welding bump, and the second plate welding zone does not comprise a welding bump,
wherein the method comprises the following steps:
arranging the first metal plate and the second metal plate in a laser beam welding position, such that:
the first channel structure and the second channel structure are positioned to form the flow field channel pattern; and
the welding bump of the first metal plate is projecting towards the second plate welding zone of the second metal plate;
fixing the first metal plate and the second metal plate in the laser beam welding position by:
using at least one welding fixture, wherein the at least one welding fixture engages the first metal plate next to the first plate welding zone and/or the second metal plate next to the second plate welding zone, and/or
reducing a pressure of air between the first metal plate and the second metal plate, thereby providing a suction force, and
connecting the first plate welding zone and the second plate welding zone to each other by welding.
